(19) United States
(12) Patent Application Publication
(10) Pub. No.: US 2018/0305610 A1
(43) Pub. Date: Oct. 25, 2018

(54) METHOD FOR PREPARING BAUXITE AND/OR KAOLIN FOR USE IN CERAMIC PROPPANTS

(71) Applicant: Imerys Oilfield Minerals, Inc., Roswell, GA (US)

(72) Inventors: Machen GARRETT, Tennille, GA (US); Robert J. PRUETT, Milledgeville, GA (US); Sayre MENDER, Milledgeville, GA (US); Mike BLEVINS, Spanish Fort, AL (US)

(21) Appl. No.: 15/525,795

(22) PCT Filed: Nov. 10, 2015
(86) PCT No.: PCT/US15/59945

§ 371 Date: May 10, 2017

Related U.S. Application Data
(60) Provisional application No. 62/077,723, filed on Nov. 10, 2014.

(51) Int. Cl. C09K 8/80; C04B 33/04; C04B 33/32; C04B 35/10; C04B 35/626; C04B 35/64

(52) U.S. Cl. CPC C09K 8/80; C04B 33/04; C04B 33/323; C04B 35/10; C04B 2235/349; C04B 35/62695; C04B 35/64; C04B 35/62655; C04B 2235/3217; C04B 35/6261

(57) ABSTRACT

A method of preparing a mineral ore may include crushing the mineral ore via a crusher apparatus to form crushed mineral ore. The method may further include depositing the crushed mineral ore into a media mill and adding water and dispersant into the media mill to form a slurry of the crushed mineral ore. The method may further include operating the media mill to grind the crushed mineral ore to form a slurry of ground mineral ore, and separating media of the media mill from the slurry of the ground mineral ore. The mineral ore may include at least one of bauxite and kaolin. For example, the mineral ore may include at least one of crude bauxite and crude kaolin, and crushing the mineral ore may include crushing the at least one of crude bauxite and crude kaolin. The method may be used to prepare a feed for use in ceramic proppants.

### CLAIM FOR PRIORITY

This PCT International Application claims the benefit of priority of U.S. Provisional Patent Application No. 62/077,723, filed Nov. 10, 2014, the subject matter of which is incorporated herein by reference in its entirety.

### DESCRIPTION

### Field of the Disclosure

The present disclosure relates to methods for preparing bauxite and/or kaolin, and more particularly, to methods for preparing bauxite and/or kaolin for use in ceramic proppants.

### Background

Naturally occurring deposits containing oil and natural gas are located throughout the world. Given the porous and permeable nature of the subterranean structure, it is possible to bore into the earth and set up a well where oil and natural gas are pumped out of the deposit. These wells are large, costly structures that are typically fixed at one location. As is often the case, a well may initially be very productive, with the oil and natural gas being pumpable with relative ease. As the oil or natural gas near the well bore is removed from the deposit, other oil and natural gas may flow to the area near the well bore so that it may be pumped as well. However, as a well ages, and sometimes merely as a consequence of the subterranean geology surrounding the well bore, the more remote oil and natural gas may have difficulty flowing to the well bore, thereby reducing the productivity of the well.

To address this problem and to increase the flow of oil and natural gas to the well bore, a technique may be employed of fracturing the subterranean area around the well to create more paths for the oil and natural gas to flow toward the well bore. This fracturing may be performed by hydraulically injecting a fracturing fluid at high pressure into the area surrounding the well bore. This fracturing fluid is thereafter removed from the fracture to the extent possible so that it does not impede the flow of oil or natural gas back to the well bore. Once the fracturing fluid is removed, however, the fractures may tend to collapse due to the high compaction pressures experienced at well-depths, which may exceed 20,000 feet.

To reduce the likelihood of the fractures closing, a propping agent, also known as a “proppant” or “anti-flowback additive,” may be included in the fracturing fluid, so that as much of the fracturing fluid as possible may be removed from the fractures while leaving the proppant behind to hold the fractures open. As used in this application, the term “proppant” refers to any non-liquid material that is present in a proppant pack (a plurality of proppant particles) and provides structural support in a propped fracture. “Anti-flowback additive” refers to any material that is present in a proppant pack and reduces the flowback of proppant particles but still allows for production of oil at desired rates. The terms “proppant” and “anti-flowback additive” are not necessarily mutually exclusive, so a single particle type may meet both definitions. For example, a proppant particle may provide structural support in a fracture, and it may also be shaped to have anti-flowback properties, allowing it to meet both definitions.

Because there may be extremely high closing pressures in fractures, it may be desirable to provide proppants and anti-flowback additives that have a high crush resistance. For example, the useful life of the well may be shortened if the proppant particles break down, allowing the fractures to collapse and/or clog with “fines” created by the broken-down proppant particles. For this reason, it may be desirable to provide proppants that are resistant to breakage, even under high crush pressures.

In addition, it may also be desirable to provide a proppant or anti-flowback additive that packs well with other proppant particles and the surrounding geological features, so that the nature of this packing of particles does not unduly impede the flow of the oil and natural gas through the fractures. For example, if the proppant particles become too tightly packed and create low porosity, they may actually inhibit the flow of the oil or natural gas to the well bore rather than increase it.

The nature of the packing may also affect the overall turbulence generated as the oil or natural gas flows through the fractures. Too much turbulence may increase the flowback of the proppant particles from the fractures toward the well bore, which may undesirably decrease the flow of oil and natural gas, contaminate the well, cause abrasion to the equipment in the well, and/or increase the production cost as the proppants that flow back toward the well must be removed from the oil and natural gas. In addition, too much turbulence may also increase a non-Darcy flow effect, which may ultimately result in decreased conductivity.

As conventional oil and gas hydrocarbon resources become scarcer, the search for oil and natural gas may involve penetration into deeper geological formations or geological formations having lower porosity and permeability, and the recovery of oil and gas resources become increasingly difficult. Therefore, there may be a desire to provide proppants and anti-flowback additives that have an excellent conductivity and permeability under extreme conditions. In addition, there may be a desire to provide proppants and anti-flowback additives formed from less costly or more prevalent materials that still provide one or more desirable characteristics for propping fractures in modern wells.

Ceramic proppants and anti-flowback additives have been formed from mined clays and minerals, such as, for example, crude bauxite and/or crude kaolin, which after mining is processed to achieve a desired form and agglomerated into green pellets, which may be sintered to form ceramic proppants. However, conventional methods for processing the crude mineral ore may suffer from inefficiencies. Thus, it may be desired to develop processing methods that improve one or more of the efficiency of the process and the properties of the proppants. The present disclosure may mitigate or overcome drawbacks associated with conventional processing methods.

### SUMMARY

According to one aspect, a method of preparing a mineral ore may include crushing the mineral ore via a crusher apparatus to form crushed ore. The method may further include depositing the crushed mineral ore into a media mill and adding water and dispersant into the media mill to form a slurry of mineral ore and water. The method may further include operating the media mill to grind the mineral slurry to form a slurry of ground mineral, and separating media of the media mill from the slurry of the ground mineral. According to some aspects, the mineral may include any of those common in bauxite and kaolin. For example, the mineral ore may include at least one of gibbsite, diaspore, and bohemite that occur in crude bauxite ore, and the mineral may include at least one of kaolinite, halloysite, dickite, and nacrite that occur in crude kaolin ore, or a mixture of these aforementioned minerals in an ore including bauxite, kaolin, bauxitic kaolin, flint clay, or a blend including a mixture of these aforementioned rock types.

According to a further aspect, the method may include feeding the crushed ore from the crusher apparatus directly to the media mill. According to a further aspect, the media mill may include at least one stirred media mill, and operating the media mill may include operating the at least one stirred media mill. For example, the media mill may include media including at least one of steel media or ceramic media. According to another aspect, the at least one stirred media mill may include a sand grinder or attrition mill, such as, for example, at least one of a stirred media mill having bars perpendicular to a rotating shaft, such as an ECC grinder, or a stirred media mill having a cage rotor on a rotating shaft, such as a GK grinder.

According to a further aspect, operating the media mill to grind the crushed ore may include depositing the crushed ore into a first media mill, and adding the water and the dispersant into the first media mill to form the slurry of the liberated mineral, unliberated mineral, or both. The method may further include operating the first media mill to grind the ore to form the slurry of the ground mineral, and depositing the slurry of the ground mineral, liberated mineral, and/or unliberated mineral into a second media mill. The method may further include operating the second media mill to grind the slurry of the ground mineral. In some aspects, the method may include a cascade of more than two media mills.

According to yet another aspect, the crusher apparatus may include at least one of a jaw crusher, vertical shaft impactor, and/or a horizontal shaft impactor.

According to still a further aspect, the dispersant may include at least one of sodium lignosulfonate, sodium polyacrylate, and sodium polyphosphate. In another aspect, the dispersant may include one or more of colloids (organic polymers), polyelectrolytes, tetra sodium pyrophosphate, tetra potassium pyrophosphate, polyphosphate, ammonium citrate, alkali silicate (e.g. sodium silicate, potassium silicate, and/or similar silicates), or ferric ammonium citrate.

According to another aspect, the slurry of the crushed mineral may have a solids content ranging from about 30 wt % to about 75 wt %. The method may further include raising the pH of the slurry of the crushed mineral to 7 or more, for example, by adding ammonium hydroxide, sodium hydroxide, or sodium carbonate to form the mineral slurry.

According to another aspect, the method may further include separating any grit particles from the slurry of the ground mineral. For example, separating the grit particles may include separating the grit particles via at least one of a hydrocyclone and a screen. Grit particles are those particles greater than 44-micron that can comprise of at least one of the following: rock fragments (aggregates of unliberated minerals), mineral, or unblunged mineral agglomerates.

According to still another aspect, the method may further include feeding the slurry of the ground mineral into a spray-fluidizer and operating the spray-fluidizer to form green pellets. According to still another aspect, the method may further include sintering the green pellets to form ceramic proppants. According to still a further aspect, the method may further include sizing the sintered pellets to form ceramic proppants.

According to yet another aspect, the slurry of the ground mineral may have a Brookfield viscosity ranging from about 1 centipoise (cps) to about 1000 cps using a #2 spindle at 20 rpm at 65% equivalent solids. For example, the slurry of the ground mineral may have a Brookfield viscosity ranging from about 20 cps to about 200 cps using a #2 spindle at 20 rpm at 65% equivalent solids.

According to still another aspect, a method of forming ceramic proppants may include crushing a mineral ore via a crusher or grinding apparatus to form crushed or ground mineral, and depositing the crushed or ground mineral into a stirred media mill. The method may further include adding water and dispersant into the stirred media mill to form a slurry of the mineral, and operating the stirred media mill to grind the mineral ore to form a slurry of ground mineral. The method may further include separating grinding media of the media mill from the slurry of the ground mineral, and forming the ground mineral into green pellets. The method may further include sintering the green pellets to form ceramic proppants, wherein the mineral ore comprises at least one of bauxite and kaolin. For example, the mineral ore may include at least one of crude bauxite and crude kaolin, and crushing the mineral ore may include crushing the at least one of crude bauxite and crude kaolin.

According to a further aspect, the method of forming ceramic proppants may not include one or more of blunging the mineral ore, blunging the crushed mineral ore, or blunging the ground mineral ore. For example, the method may not include blunging the mineral ore, may not include blunging the crushed mineral ore, and may not include blunging the ground mineral ore.

According to a further aspect, the method of forming ceramic proppants may also include feeding the crushed mineral ore from the crusher apparatus directly to the media mill. According to a further aspect, the media mill may include at least one stirred media mill, and operating the media mill may include operating the at least one stirred media mill. For example, the media mill may include media including at least one of steel media and ceramic media. According to another aspect, the at least one stirred media mill may include a sandgrinder or attrition mill, such as, for example, at least one of a grinder having bars protruding from a rotating shaft into grinding media, such as an ECC grinder, and a grinder having a cage rotor stirring the grinding media, such as a GK grinder.

According to a further aspect, operating the media mill to grind the crushed mineral ore may include depositing the crushed mineral ore into a first media mill, and adding the water and the dispersant into the first media mill to form the slurry of the crushed mineral ore. The method of forming ceramic proppants may further include operating the first media mill to grind the crushed mineral ore to form the slurry of the ground mineral ore, and depositing the slurry of the ground mineral ore into a second media mill. The method may further include operating the second media mill to grind the slurry of the ground mineral ore.

According to yet another aspect, the crusher apparatus may include at least one of a roll crusher, a jaw crusher, a vertical shaft impactor, or a horizontal shaft impactor.

According to still a further aspect, the dispersant may include at least one of sodium lignosulfonate, sodium polyacrylate, and sodium polyphosphate.

According to another aspect, the slurry of the crushed mineral ore may have a solids content ranging from about 30 wt % to about 75 wt %. The method of forming the ceramic proppants may further include raising the pH of the slurry of the crushed mineral ore to 7 or more, for example, by adding ammonium hydroxide to the slurry of the crushed mineral ore.

According to another aspect, the method of forming ceramic proppants may further include separating any grit particles from the slurry of the ground mineral ore. For example, separating the grit particles may include separating the grit particles via at least one of a hydrocyclone and a screen.

According to still another aspect, the method of forming ceramic proppants may further include feeding the slurry of the ground mineral ore into a spray-fluidizer and operating the spray-fluidizer to form the green pellets. According to still another aspect, the method may further include sintering the green pellets to form the ceramic proppants. According to still a further aspect, the method may further include sizing the sintered pellets to form the ceramic proppants.

According to yet another aspect, the slurry of the ground mineral ore may have a Brookfield viscosity ranging from about 1 centipoise (cps) to about 1000 cps using a #2 spindle at 20 rpm at 65% equivalent solids. For example, the slurry of the ground mineral ore may have a Brookfield viscosity ranging from about 20 cps to about 200 cps using a #2 spindle at 20 rpm at 65% equivalent solids.

It is to be understood that both the foregoing general description and the following detailed description are exemplary and explanatory only and are not restrictive of the invention.

### BRIEF DESCRIPTION OF THE DRAWING

FIG. 1 is a schematic diagram of an exemplary method for processing mineral ores to provide a feed suitable for making, for example, ceramic proppants.

### DESCRIPTION OF EXEMPLARY EMBODIMENTS

Reference will now be made to exemplary embodiments.

Applicant has surprisingly found that grinding crushed crude mineral ore, such as, for example, crude bauxite and crude kaolin, using one or more media mills may result in improved efficiencies when processing the mineral ores to produce ceramic proppants. For example, it may result in an improved throughput in a ceramic proppant manufacturing facility. In addition, Applicant has surprisingly found that grinding crushed crude mineral ores using one or more media mills may result in improved characteristics of the ceramic proppants produced from the resulting processed minerals. For example, according to some embodiments, it may be possible to produce the ceramic proppants without blunging the mineral ores. According to some embodiments, the final stage of the media milled minerals may contain substantially no large (e.g., unblunged-size) kaolin aggregates and may have a paucity of grit-sized bauxite minerals. According to some embodiments of the methods, the methods may result in potential advantages, such as, for example, (a) the potential omission of conventional degritting stages and resultant waste tailings streams, (b) a more robust green pellet as compared to conventional processes, (c) the ability to recover alumina from large gibbsite crystals and aggregates cemented by alumina, iron or other cementing agents in the mineral ore by micronizing and dispersing them into the process, and (d) the possibility to achieve a fine-ground dispersed bauxite slurry that may be suitable for making ceramic proppants of intermediate and high strength.

According to some embodiments, a method of preparing a mineral (e.g., preparing a mineral feed for forming ceramic proppants) may include crushing the mineral ore via a crusher apparatus to form crushed mineral ore. The method may further include depositing the crushed mineral ore into a media mill and adding water and dispersant into the media mill to form a slurry of the crushed mineral ore. The method may further include operating the media mill to grind the crushed mineral ore to form a slurry of ground mineral ore, and separating media of the media mill from the slurry of the ground mineral ore. According to some embodiments, the mineral ore may include at least one of bauxite and kaolin. For example, the mineral ore may include at least one ore common to bauxite and common to kaolin, and crushing the ore may include crushing the at least one of crude bauxite and crude kaolin.

According to some embodiments, the method may not include one or more of blunging the mineral ore, blunging the crushed mineral ore, or blunging the ground mineral ore. For example, the method may not include blunging the mineral ore, may not include blunging the crushed mineral ore, and may not include blunging the ground mineral ore.

According to some embodiments, the method may include feeding the crushed mineral ore from the crusher apparatus directly to the media mill. According to some embodiments, the media mill may include at least one stirred media mill, and operating the media mill may include operating the at least one stirred media mill. For example, the media mill may include media including at least one of steel media (e.g., half-inch steel media) and ceramic media (e.g., 16 by 20 mesh ceramic media). According to some embodiments, the at least one stirred media mill may include a sandgrinder or attrition mill, such as, for example, at least one of a grinder having bars perpendicular to a rotating shaft, such as an ECC grinder, or a grinder having a cage rotor on a rotating shaft, such as a GK grinder.

Examples of GK grinders and ECC grinders are disclosed in U.S. Pat. No. 3,750,710 and U.S. Patent Application Publication No. US 2004/0033765 A1, respectively. The ECC grinders may or may not include pitched rotors such as those disclosed in the U.S. patent publication, but may be otherwise similar.

According to some embodiments, operating the media mill to grind the crushed ore may include depositing the crushed ore into a first media mill (e.g., a primary media mill), and adding the water and the dispersant into the first media mill to form the slurry of the crushed mineral ore. According to some embodiments, the method may further include operating the first media mill to grind the mineral ore to form the slurry of the ground mineral ore, and depositing the slurry of the ground mineral ore into a second media mill (e.g., a secondary media mill). The method may further include operating the second media mill to grind the slurry of the ground mineral ore. According to some embodiments, the primary and secondary media mills may be the same type of media mill. According to some embodiments, the primary and secondary media mills may be different types of media mills.

According to some embodiments, the crusher apparatus may include at least one of a jaw crusher and a horizontal shaft impactor. Other suitable types of crushers are contemplated.

According to some embodiments, the dispersant may include at least one of sodium lignosulfonate, sodium polyacrylate, and sodium polyphosphate.

According to some embodiments, the slurry of the crushed mineral ore may have a solids content ranging from about 30 wt % to about 75 wt %. For example, the slurry of the crushed mineral ore may have a solids content ranging from about 45 wt % to about 70 wt % or from about 50 wt % to about 70 wt %. According to some embodiments, water may be added the slurry of ground mineral ore to reduce the solids content to about 50 wt %.

According to some embodiments, the method may further include raising the pH of the slurry of the crushed mineral ore to 7 or more. For example, the pH may be increased by adding ammonium hydroxide and/or other suitable additives to the slurry of the crushed mineral ore to increase the pH.

According to some embodiments, the method may further include separating any grit particles (e.g., quartz grit particles) from the slurry of the ground mineral ore. For example, separating the grit particles may include separating the grit particles via at least one of a hydrocyclone and a screen. For example, a 325 mesh (˜44 μm) screen may be used.

According to some embodiments, the method may further include agglomerating the ground mineral ore. For example, the method may further include feeding the slurry of the ground mineral ore into a spray-fluidizer and operating the spray-fluidizer to form green pellets. According to some embodiments, the method may further include sintering the green pellets to form ceramic proppants. According to some embodiments, the method may further include sizing the sintered pellets to form ceramic proppants. Conventional sizing techniques known in the art may be used.

According to some embodiments, the slurry of the ground mineral ore may have a Brookfield viscosity ranging from about 1 centipoise (cps) to about 1000 cps using a #2 spindle at 20 rpm at 65% equivalent solids. For example, the slurry of the ground mineral ore may have a Brookfield viscosity ranging from about 20 cps to about 200 cps using a #2 spindle at 20 rpm at 65% equivalent solids.

Brookfield viscometers provide a measure of a low shear viscosity of an inorganic particulate suspension, for example, a kaolin slurry, expressed in units of centipoise (cps). One centipoise is equal to one centimeter-gram-second unit. (One centipoise is one one-hundredth (1×10⁻²) of a poise.) Thus, all other things being equal, a 100 centipoise sample has a lower viscosity than a 500 centipoise sample.

According to some embodiments, a method of forming ceramic proppants may include crushing a mineral ore via a crusher apparatus to form crushed ore, and depositing the crushed ore into a media mill. The method may further include adding water and dispersant into the media mill to form a slurry of the mineral ore, and operating the media mill to grind the mineral ore to form a slurry of ground mineral ore. The method may further include separating media of the media mill from the slurry of the ground mineral ore, and forming the ground mineral ore into green pellets. The method may further include sintering the green pellets to form ceramic proppants, wherein the mineral ore prior to sintering comprises at least one of common in bauxite and/or kaolin. For example, the mineral ore may include at least one of gibbsite, diaspore or bohemite that occur in crude bauxite, and may include at least one of kaolinite, halloysite, dickite, and/or nacrite that occur in crude kaolin. Crushing the mineral ore may include crushing the at least one of crude bauxite and crude kaolin.

According to some embodiments, the method of forming ceramic proppants may not include one or more of blunging the mineral ore, blunging the crushed mineral ore, or blunging the ground mineral ore. For example, the method may not include blunging the mineral ore, may not include blunging the crushed mineral ore, and may not include blunging the ground mineral ore.

According to some embodiments, the method of forming ceramic proppants may include feeding the crushed mineral ore from the crusher apparatus directly to the media mill. According to some embodiments, the media mill may include at least one stirred media mill, and operating the media mill may include operating the at least one stirred media mill. For example, the media mill may include media including at least one of steel media and ceramic media. According to some embodiments, the at least one stirred media mill may include a sandgrinder or attrition mill, such as, for example, at least one of a grinder having bars protruding from a rotating shaft into grinding media, such as an ECC grinder, and a grinder having a cage rotor stirring the grinding media, such as a GK grinder.

According to some embodiments, operating the media mill to grind the crushed mineral ore may include depositing the crushed mineral ore into a first media mill, and adding the water and the dispersant into the first media mill to form the slurry of the crushed mineral ore. The method of forming ceramic proppants may further include operating the first media mill to grind the crushed mineral ore to form the slurry of the ground mineral ore, and depositing the slurry of the ground mineral ore into a second media mill for further size reduction. The method may further include operating the second media mill to grind the slurry of the ground mineral ore.

According to some embodiments, the crusher apparatus may include at least one of a jaw crusher and a horizontal shaft impactor.

According to some embodiments, the dispersant may include at least one of sodium lignosulfonate, sodium polyacrylate, and sodium polyphosphate.

According to some embodiments, the slurry of the crushed mineral ore may have a solids content ranging from about 30 wt % to about 75 wt %. The method of forming the ceramic proppants may further include raising the pH of the slurry of the crushed mineral ore to 7 or more, for example, by adding ammonium hydroxide to the slurry of the crushed mineral ore.

According to some embodiments, the method of forming ceramic proppants may further include separating any grit particles from the slurry of the ground mineral ore. For example, separating the grit particles may include separating the grit particles via at least one of a hydrocyclone and a screen.

According to some embodiments, the method of forming ceramic proppants may further include feeding the slurry of the ground mineral ore into a spray-fluidizer and operating the spray-fluidizer to form the green pellets. According to some embodiments, the method may further include sintering the green pellets to form the ceramic proppants. According to some embodiments, the method may further include sizing the sintered pellets to form the ceramic proppants.

According to some embodiments, the slurry of the ground mineral ore may have a Brookfield viscosity ranging from about 1 centipoise (cps) to about 1000 cps using a #2 spindle at 20 rpm at 65% equivalent solids. For example, the slurry of the ground mineral ore may have a Brookfield viscosity ranging from about 20 cps to about 200 cps using a #2 spindle at 20 rpm at 65% equivalent solids.

According to one exemplary method, crude bauxite and/or crude kaolin may be crushed via a crusher, such as a jaw crusher and/or a horizontal shaft impactor. Thereafter, the crushed mineral ore may be fed directly into a single stirred media mill or series of stirred media mills, such as, for example, one or more ECC media mills and/or GK media mills. Water and dispersant are added with the crushed ore into a primary stirred media mill to make a dispersed kaolin-water slurry having a solids content ranging from about 50 wt % to about 70 wt %. The media in the primary stirred media mill may be a half-inch steel media. In some examples, a secondary media mill may be used to further grind the ground mineral ores, and the secondary stirred media mill may use smaller media, such as, for example, 16 by 20 mesh ceramic media. The pH may be adjusted in the primary media mill using a pH adjuster such as ammonium hydroxide. The dispersant used in the primary stirred media mill may be a single dispersant, or when the mineral is bauxite, a combination of dispersants, such as, for example, sodium lignosulfonate, sodium polyacrylate, and/or sodium polyphosphate. A screen may be placed after the last stirred media mill in the sequence to separate out any grinding media contained in the slurry. For kaolin containing grit particles (e.g., quartz grit particles), a hydrocyclone and/or screen may be used to separate out those grit particles for removal. According to some methods, the final stage stirred media mill product may contain no unblunged kaolin aggregates and a paucity of bauxite particles.

### Examples

Table 1 below shows the results of exemplary processing of seventeen Samples. The Samples include processing of the following mineral ores: high iron Arkansas bauxite (Samples 1-8), middle Georgia bauxite (Samples 9-13), middle Georgia high alumina (Al₂O₃) kaolin (Samples 14-16), and low iron Arkansas bauxite (Sample 17).

TABLE 1

| | | | | | | | | | | Brook | | | | | | | | | |
|---|---|---|---|---|---|---|---|---|---|---|---|---|---|---|---|---|---|---|---|
| | | Grinder | | | | | Dispersion | | | field | Malvern | | Sedigraph (<325 | | | +325 Mesh | | <325 Mesh | |
| Ore Type | | | Shaft | | | kW- | | Dose | | cP @ | Vol. % | D₅₀ | mesh fraction) | | | | Al₂O₃ | Al₂O₃ | Fe₂O₃ |
| Test # | Material Tested | Feed | Type | Media | Solids | hr/dst | Chemical | (#/dst) | pH | 20 rpm | <0.244 μm | (μm) | 0.25 um | 2.0 um | 10.0 um | wt. % | wt. % | wt. % | wt. % |
| Arkansas | Raw Ore | | | | | | | | | | | | 4.9 | 28.3 | 93.6 | 35.0 | | | |
| Bauxite-1 | | | | | | | | | | | | | | | | | | | |
| | Blunged | | | | | | | | | | | | | | | 40.2 | | | |
| Test 1 | Grinder Product | Raw Ore | Bar | 0.5″ | 56% | 36 | Na | 29.1 | 8.1 | 1097 | 14.6 | 4.65 | | | | 15.0 | | | |
| | | | | Steel | | | Polyacrylate | | | | | | | | | | | | |
| Test 2 | Grinder Product | Raw Ore | Bar | 0.5″ | 55% | 36 | Na | 1.3 | 9.3 | 58 | 14.7 | 6.27 | | | | 9.4 | | | |
| | | | | Steel | | | Lignosulfonate | | | | | | | | | | | | |
| | | | | | | | Na₆P₈O₁₈ | 3.5 | | | | | | | | | | | |
| | | | | | | | Na | 5.3 | | | | | | | | | | | |
| | | | | | | | Polyacrylate | | | | | | | | | | | | |
| Test 3 | Grinder Product | Test 2 | Cage | 16 × 20 | 55% | 35 | Na₆P₈O₁₈ | 1.8 | 7.6 | 186 | 23.8 | 1.08 | | | | 0.0 | | | |
| | | | | mesh | | | | | | | | | | | | | | | |
| | | | | ceramic | | | | | | | | | | | | | | | |
| | | | | | | | Na | 2.7 | | | | | | | | | | | |
| | | | | | | | Polyacrylate | | | | | | | | | | | | |
| Arkansas | Raw Ore | | | | | | | | | | 0.2 | 2.82 | | | | 24.0 | | | |
| Bauxite-2 | | | | | | | | | | | | | | | | | | | |
| | Blunged | | | | | | | | | | | | | | | 27.4 | | | |
| Test 4 | Grinder Product | Raw Ore | Bar | 0.5″ | 53% | 14 | Na | 0.6 | 8.0 | 22 | 14.7 | 3.49 | 10.9 | 50.9 | 87.2 | 7.4 | | | |
| | | | | Steel | | | Lignosulfonate | | | | | | | | | | | | |
| | | | | | | | Na₆P₈O₁₈ | 3.5 | | | | | | | | | | | |
| | | | | | | | Na | 5.3 | | | | | | | | | | | |
| | | | | | | | Polyacrylate | | | | | | | | | | | | |
| Test 5 | Grinder Product | Test 4 | Cage | 16 × 20 | 56% | 26 | | | 8.1 | 30 | 15.2 | 2.57 | 15.3 | 52.9 | 93.3 | 0.0 | | | |
| | | | | mesh | | | | | | | | | | | | | | | |
| | | | | ceramic | | | | | | | | | | | | | | | |
| Georgia | Raw Ore | | | | | | | | | | | | 2.5 | 3.4 | 99.2 | 47.9 | | | |
| Bauxite | | | | | | | | | | | | | | | | | | | |
| | Blunged | | | | | | | | | | | | | | | 62.2 | 79.0 | 57.6 | 1.44 |
| Test 6 | Grinder Product | Raw Ore | Bar | 0.5″ | 62% | 41 | Na | 9.7 | 8.1 | 36 | 18.7 | 2.09 | 17.7 | 65.5 | 94.3 | 3.0 | | | |
| | | | | Steel | | | Polyacrylate | | | | | | | | | | | | |
| Test 7 | Grinder Product | Test 6 | Cage | 16 × 20 | 60% | 33 | | | 8.1 | 62 | 26.7 | 0.56 | 23.9 | 85.8 | 99.5 | 0.0 | | | |
| | | | | mesh | | | | | | | | | | | | | | | |
| | | | | ceramic | | | | | | | | | | | | | | | |
| High | Raw Ore | | | | | | | | | | | | 21.7 | 58.6 | 92.1 | 4.4 | | | |
| Alumina | | | | | | | | | | | | | | | | | | | |
| Kaolin | | | | | | | | | | | | | | | | | | | |
| | Blunged | | | | | | | | | | | | | | | | | | |
| Test 8 | Grinder Product | Raw Ore | Bar | 0.5″ | 60% | 38 | Na | 5.52 | 8.4 | 62 | 9.8 | 4.43 | 16.3 | 59.0 | 92.1 | 0.6 | | | |
| | | | | Steel | | | Polyacrylate | | | | | | | | | | | | |
| Test 9 | Grinder Product | Test 8 | Cage | 16 × 20 | 59% | 26 | | | 8.2 | 122 | 10.2 | 4.30 | 19.2 | 69.8 | 98.4 | 0.2 | | | |
| | | | | mesh | | | | | | | | | | | | | | | |
| | | | | ceramic | | | | | | | | | | | | | | | |
| Test 10 | Blunger Product | Raw Ore | Blunger | | 58% | | Na | 10.3 | 7.5 | | | | 22.9 | 71.1 | 95.0 | 5.8 | 59.4 | 47.7 | 0.49 |
| | | | | | | | Polyacrylate | | | | | | | | | | | | |
| Test 11 | Grinder Product | Test 10 | Cage | 16 × 20 | 55% | 43 | | | 7.0 | 170 | 8.6 | 4.45 | 21.4 | 70.2 | 98.2 | 0.0 | | | |
| | | | | mesh | | | | | | | | | | | | | | | |
| | | | | ceramic | | | | | | | | | | | | | | | |
| Kaolin | Raw Ore | | | | | | | | | | | | 41.7 | 85.7 | 96.8 | 12.0 | | | |
| | Blunged | | | | | | | | | | | | | | | 14.0 | | | |
| Test 12 | Blunger Product | | Blunger | | 57% | | Na | 9.8 | 7.8 | | | | 45.7 | 89.6 | 97.3 | 5.0 | 3.7 | 44.6 | 1.06 |
| | | | | | | | Polyacrylate | | | | | | | | | | | | |
| Test 13 | Grinder Product | | Cage | 16 × 20 | 59% | 11 | | | 7.3 | 144 | 40.7 | 0.30 | 49.9 | 94.3 | 99.5 | 0.0 | | | |
| | | | | mesh | | | | | | | | | | | | | | | |
| | | | | ceramic | | | | | | | | | | | | | | | |

In Table 1, proppant samples were prepared using a variety of different feed materials including two types of Arkansas bauxite, a middle Georgia bauxite and a middle Georgia high alumina kaolin, and an east Georgia kaolin.

For Arkansas bauxite 1, raw ore was tested in the lab to determine initial grit level by blunging twice to first remove unbound particles <325 mesh and then <325 mesh particles from unblunged kaolin and bauxite agglomerates. After blunging to remove 60% unbound <325 mesh particles and blunging again to remove an additional 5%<325 mesh particles from aggregates, the initial >325 mesh grit level of this crude was determined to be approximately 35%. Test 1 shows that the grit level decreases to approximately 15% after primary grinding the crude in a media mill using a half-inch steel ball media, instead of blunging when using the same ore. Test 2, a repeat of Test 1 on the same ore but with an improved dispersant chemical package, shows that the grit level may be further decreased to less than 10% by using a blend of metaphosphate, polyacrylate, and lignosulfonate dispersants. Test 3 shows that the grit level can be reduced to approximately zero by subjecting the material of test 2 to a secondary media grinding step using 16 by 20 mesh ceramic grinding media in the presence of metaphosphate and polyacrylate dispersants. Note that the secondary grinding also resulted in a decrease in median particle size (d₅₀) and volume % of particles less than 0.25 microns (μm).

For Arkansas bauxite 2, raw ore was blunged twice in the lab to remove unbound and unblunged kaolin and/or bauxite agglomerates. After blunging twice, the initial grit level was determined to be approximately 24%. Test 4 shows that the grit level decreases to approximately 7% after primary grinding in a media mill using a half-inch steel ball media, instead of blunging when using the same ore. Test 5 shows that the grit level can again be further reduced to approximately zero by subjecting the material of Test 4 to a secondary media grinding step using 16 by 20 mesh ceramic grinding media. Note that again the secondary grinding also resulted in a decrease in median particle size (D50) and volume % of particles less than 0.25 μm and 10 μm.

For the Georgia bauxite samples, raw ore was blunged twice in the lab to remove unbound and unblunged kaolin and/or bauxite particles. The initial grit level after blunging, was approximately 48%. Test 6 shows that the grit level decreases to approximately 7% after primary grinding in a media mill using a 0.5 inch steel ball media in the presence of a polyacrylate dispersant, instead of blunging. Test 7 shows that the grit level can again be further reduced to approximately zero by subjecting the material of Test 6 to a secondary media grinding step using 16 by 20 mesh ceramic grinding media. Note the high alumina content of the >325 mesh fraction. This is due to the presence of gibbsitic particles that are too coarse to be used in the wet process without grinding

For the Georgia high alumina kaolin samples, raw ore was blunged in the lab in the presence of polyacrylate dispersant to remove unbound kaolin particles to an initial grit level of approximately 4%. The same crude was blunged using a pilot continuous blunger to simulate plant blunging, the grit level was approximately 6% (see Test 10). Test 8 shows that the grit level decreases to approximately 0.6% after primary grinding in a media mill using a half-inch steel ball media in the presence of a polyacrylate dispersant, instead of blunging. Test 9 shows that the grit level can further be reduced to approximately zero by subjecting the material of Test 8 to a secondary media grinding step using 16 by 20 mesh ceramic grinding media. Note the high alumina content of the >325 mesh fraction. This is due to the presence of high alumina gibbsitic particles too coarse to be used in the wet process. Test 11 illustrates that similar reduction in grit to that of the two stage grinding process of Test 9 can be achieved using a blunging step followed by grinding directly in the secondary grinder using the 16 by 20 ceramic media.

For the east Georgia kaolin samples, raw ore was blunged twice in the lab using a polyacrylate dispersant. After blunging, the grit level was approximately 12%. Test 12 shows that the grit level decreases to approximately 5% after blunging in a continuous pilot plant blunger. Test 13 shows that the grit level can again be reduced to approximately zero by subjecting the material of Test 12 to a secondary media grinding step using 16 by 20 mesh ceramic grinding media. Note the >325 mesh fraction in this example is largely composed of quartz sand that is desirable to remove. Also note that the grinding has a relatively small effect on the particle size of the kaolin.

TABLE 2

| | | | | | | | | | | Brook |
|---|---|---|---|---|---|---|---|---|---|---|
| | | Grinder | | | | | Dispersion | | | field |
| Ore Type | | | Shaft | | | kW- | | Dose | | cP @ |
| Test # | Material Tested | Feed | Type | Media | Solids | hr/dst | Chemical | (#/dst) | pH | 20 rpm |
| Arkansas | Raw Ore | | | | | | | | | |
| Bauxite-3 | | | | | | | | | | |
| Test 14 | Grinder Product | Raw Ore | Bar | 0.5″ Steel | 55-62 | 20 to | Na | 0.6 | 7.5 | 46 |
| | | | | | | 40 | Lignosulfonate | | to | |
| | | | | | | | | | 9.8 | |
| | | | | | | | Na₆P₈O₁₈ | 3.5 | | |
| | | | | | | | Na | 5.3 | | |
| | | | | | | | Polyacrylate | | | |
| Test 15 | Grinder Product | Test 14 | Cage | 16 × 20 | 56-61 | 62 | | | 8.3 | 51 |
| | | | | mesh | | | | | to | |
| | | | | ceramic | | | | | 9.1 | |
| | Screened Product | Test 15 | | | | | | | | |

| | | Malvern | | | | | | | | +325 |
|---|---|---|---|---|---|---|---|---|---|---|
| Ore Type | | Vol. % | D₅₀ | Sedigraph (<325 mesh fraction, wt. %) | | | | | | Mesh |
| Test # | Material Tested | <0.244 μm | (μm) | <10 um | <5 um | <2 um | <1 um | <0.5 um | <0.25 um | wt. % |
| Arkansas | Raw Ore | 14.3 | 4.38 | 87.5 | 75.7 | 57.5 | 42.3 | 25.1 | 11.8 | 28.7 |
| Bauxite-3 | | | | | | | | | | |
| Test 14 | Grinder Product | 14.6 | 3.20 | 87.0 | 71.0 | 50.3 | 36.4 | 22.5 | 12.9 | 6.9 |
| Test 15 | Grinder Product | 20.1 | 1.54 | 97.5 | 91.1 | 66.9 | 48.1 | 30.3 | 16.1 | 0.3 |
| | Screened | 20.1 | 1.50 | 98.3 | 92.6 | 69.6 | 50.2 | 31.2 | 17.2 | 0.0 |
| | Product | | | | | | | | | |

In Table 2, proppant samples were prepared using an Arkansas bauxite as a feed material. Raw ore was tested in the lab to determine initial grit level by blunging to remove first remove unbound particles <325 mesh. The initial >325 mesh grit level of this crude was determined to be approximately 29%. Test 14 shows that the grit level decreases to approximately 7% after primary grinding the crude in a media mill using a half-inch steel ball media using a blend of metaphosphate, polyacrylate, and lignosulfonate dispersants, instead of blunging when using the same ore. Test 15, shows that the grit level may be reduced to approximately zero by subjecting the material of test 14 to a secondary media grinding step using 16 by 20 mesh ceramic grinding media in the presence of metaphosphate and polyacrylate dispersants and then screening.

For the above examples, an ECC grinder is generally used as the primary grinder and includes steel ball media (i.e., half-inch steel balls). An exemplary GK grinder is generally used as a secondary grinder with sand media (i.e., ImeryGrind® 16 by 20 media).

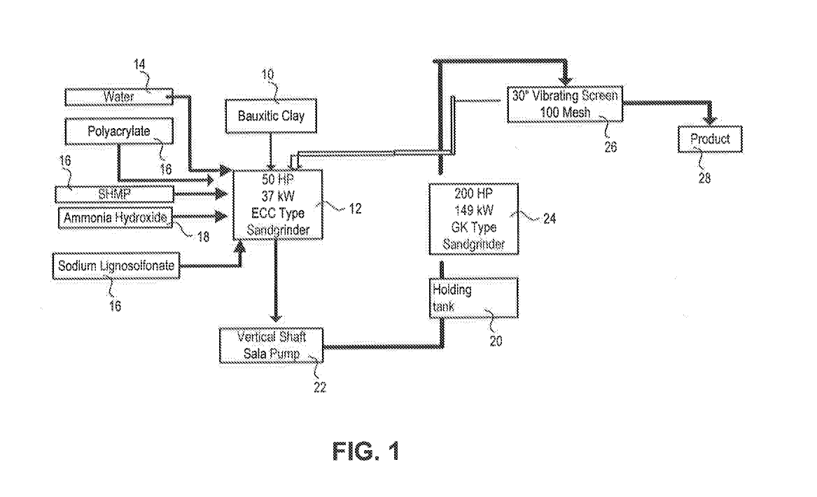

FIG. 1 shows an exemplary method for processing mineral ores to provide a feed suitable for making, for example, ceramic proppants. As shown in FIG. 1, bauxitic clay 10 is fed into a primary grinder 12, such as a stirred media mill (e.g., a shaft with perpendicular bars-type sandgrinder). Water 14, dispersants 16, and/or a pH adjuster 18 is/are added to the media mill to form a mineral ore slurry. The dispersants 16 may include one of more of polyacrylate, sodium hexametaphosphate (SHMP), and sodium lignosulfonate. The use of other dispersants is contemplated. The pH adjuster 18 may include ammonium hydroxide and may be added to the mineral ore slurry to increase the pH to, for example, 7 or greater. The primary grinder 12 may thereafter be operated to grind the ore into a mineral slurry. The slurry including the ground mineral may thereafter be pumped to a holding tank 20, for example, via a vertical shaft Sala pump 22. From the holding tank 20, the slurry including the ground mineral may be fed to a secondary grinder 24, such as a stirred media mill (e.g., a cage-type sandgrinder). Thereafter, the slurry of ground mineral may be passed through a screen 26 (e.g., a 30-inch vibrating screen of 100 mesh) to separate grinding media from the slurry. The separated grinding media and any oversized particles may be returned to the primary grinder 12 and/or the secondary grinder 24, and the feed product 28 formed by the process may be used to form, for example, ceramic proppants.

For example, according to some embodiments, a method of making a sintered ceramic proppant may include providing one or more minerals, such as for example, bauxite and/or kaolin clay, wherein the mineral ore blend may include an Al₂O₃ content greater than about 46% by weight on a fired basis. The mineral ore blend may have a particle size distribution such that greater than 20% of the particles have an equivalent spherical diameter of less than 2.0 microns as measured by Sedigraph, and a shape factor less than about 18. The method may further include grinding the mineral ore (without blunging), agglomerating the mineral ore, and sintering the agglomerated mineral ore to produce a sintered ceramic proppant.

As will be appreciated by those skilled in the art, the particle size distribution of a particulate material such as the kaolin clay may be determined by measuring the sedimentation speeds of the dispersed particles of the particulate material under test through a standard dilute aqueous suspension using a SEDIGRAPH® instrument (e.g., SEDIGRAPH 5100® obtained from Micromeritics Corporation, USA). The size of a given particle may be expressed in terms of the diameter of a sphere of equivalent diameter (i.e., the “equivalent spherical diameter” or esd), which sediments through the suspension, which may be used to characterize the particulate material. The SEDIGRAPH records the percentage by weight of particles having an esd less than a particular esd value, versus that esd value.

According to some embodiments, the mineral ore blend may have an Al₂O₃ content ranging from about 43% by weight to about 85% by weight on a fired basis, for example, an Al₂O₃ content ranging from about 46% by weight to about 53% by weight.

According to some embodiments, the mineral ore may include a blend of a first kaolin clay including not greater than about 46% by weight Al₂O₃ and a second kaolin clay including greater than about 47% by weight Al₂O₃. For example, the second kaolin clay may have an Al₂O₃ content ranging from about 49% to about 55% by weight, or from about 50% to about 53% by weight. The blend may include at least about 10% by weight of the first kaolin clay, for example, at least about 25% by weight of the first kaolin clay.

According to some embodiments, the particle size distribution of the mineral may be such that greater than 75% of the particles have an equivalent spherical diameter of less than 0.5 microns as measured by Sedigraph, such as, for example, greater than about 77%, or even greater than about 81%. For example, the particle size distribution of the mineral may be such that about 70% to about 85% of the particles have an equivalent spherical diameter of less than 0.5 microns as measured by Sedigraph, such as, for example, from about 75% to about 82%.

According to some embodiments, the particle size distribution of the mineral may be such that greater than about 90% of the particles have an equivalent spherical diameter of less than 2 microns as measured by Sedigraph, such as, for example, greater than about 93%, greater than about 94%, greater than about 95%, or even greater than about 96%. For example, the particle size distribution of the mineral may be such that greater than about 85% of the particles have an equivalent spherical diameter of less than 1 micron as measured by Sedigraph, such as, for example, greater than about 87%, greater than about 89%, greater than about 90%, or even greater than about 92%. For example, the particle size distribution of the mineral may be such that greater than about 40% of the particles have an equivalent spherical diameter of less than 0.25 microns as measured by Sedigraph, such as, for example, greater than about 45%, greater than about 50%, or even greater than about 55%.

According to some embodiments, the mineral may have a shape factor less than about 15, or less than about 10. For example, the shape factor may range from about 2 to about 15, from about 2 to about 10, or from about 5 to about 8.

A kaolin product of relatively high shape factor may be considered to be more “platey” than a kaolin product of low shape factor, which may be considered to be more “blocky.” “Shape factor” as used herein is a measure of an average value (on a weight average basis) of the ratio of mean particle diameter to particle thickness for a population of particles of varying size and shape, as measured using the electrical conductivity method and apparatus described in Great Britain No. 2,240,398, U.S. Pat. No. 5,128,606, European Patent No. 0 528 078, U.S. Pat. No. 5,576,617, and European Patent No. 631 665, and using the equations derived in these publications. For example, in the measurement method described in EP No. 0 528 078, the electrical conductivity of a fully dispersed aqueous suspension of the particles under test is caused to flow through an elongated tube. Measurements of the electrical conductivity are taken between (a) a pair of electrodes separated from one another along the longitudinal axis of the tube, and (b) a pair of electrodes separated from one another across the transverse width of the tube, and by using the difference between the two conductivity measurements, the shape factor of the particulate material under test is determined. “Mean particle diameter” is defined as the diameter of a circle, which has the same area as the largest face of the particle.

According to some embodiments, the kaolin clay particles may have a BET surface area of greater than about 15 m²/g. For example, the kaolin clay particles may have a BET surface area of greater than about 20 m²/g, or greater than about 35 m²/g. According to another aspect, the kaolin clay particles may have a BET surface area ranging from about 15 m²/g to about 35 m²/g.

According to some embodiments, the sintered ceramic proppant may have a specific gravity greater than about 2.65, or a specific gravity greater than about 2.68. For example, the specific gravity may be greater than about 2.7.

According to some embodiments, the sintered ceramic proppant may have a bulk density greater than about 1.44 g/cm³. For example, the sintered ceramic proppant may have a bulk density greater than about 1.45 g/cm³, greater than about 1.46 g/cm³, greater than about 1.47 g/cm³, or greater than about 1.48 g/cm³. For example, the sintered ceramic proppant may have a bulk density ranging from about 1.45 g/cm³ to about 1.50 g/cm³.

According to some embodiments, the crush strength measured under ISO 13503-2 of a 30/50 mesh sintered ceramic proppant at 10,000 psi may be less than about 6% fines by weight. For example, the crush strength measured under ISO 13503-2 of a 30/50 mesh sintered ceramic proppant at 10,000 psi may be less than about 5% fines by weight, or less than about 4% fines by weight.

The strength of a proppant may be indicated from a proppant crush resistance test described in ISO 13503-2: “Measurement of Properties of Proppants Used in Hydraulic Fracturing and Gravel-packing Operations.” In this test, a sample of proppant is first sieved to remove any fines (i.e., undersized pellets or fragments that may be present), then placed in a crush cell where a piston is then used to apply a confined closure stress of some magnitude above the failure point of some fraction of the proppant pellets. The sample is then re-sieved and the weight percent of fines generated as a result of pellet failure is reported as percent crush. A comparison of the percent crush of two equally sized samples is a method of gauging the relative strength of the two samples.

Permeability is part of the proportionality constant in Darcy's Law, which relates flow rate and fluid physical properties (e.g., viscosity) to the stress level applied to a proppant pack. Permeability is a property specifically relating to a proppant pack, not the fluid. Conductivity, on the other hand, describes the ease with which fluid moves through pore spaces in a proppant pack. Conductivity depends on the intrinsic permeability of a proppant pack as well as the degree of saturation. In particular, conductivity expresses the amount of water that will flow through a cross-sectional area of a proppant pack under the desired stress level.

According to some embodiments, a method of making a sintered ceramic proppant may include providing one or more minerals, such as, for example, bauxite and/or kaolin clay, wherein the mineral ore may include an Al₂O₃ content no greater than about 46% by weight. The mineral may have a particle size distribution of particles of the mineral such that greater than 70% of the particles have an equivalent spherical diameter of less than 0.5 microns as measured by Sedigraph, and an “A-bob” Hercules viscosity of at least about 3,300 rpm at 18 kilodyne-cm and 70% solids. The method may further include grinding the kaolin clay in a media mill, agglomerating the kaolin clay, and sintering the agglomerated mineral to produce a sintered ceramic proppant. According to some embodiments, the mineral may have a shape factor less than about 18. For example, the mineral may have a shape factor less than about 15, less than about 10, for example, a shape factor ranging from about 2 to about 10, or from about 5 to about 8.

According to some embodiments, a mineral, for example, a fine, blocky feed kaolin clay, may be transferred from storage to a crusher apparatus for crushing. The crushed kaolin clay may thereafter be ground in a media mill with inorganic or organic dispersant (e.g., TSPP, SHMP, Na-polyacrylate, and/or similar dispersants). Thereafter, the ground feed kaolin clay may be wet-screened, after which the feed kaolin clay may be fluidized for agglomeration. According to some embodiments, agglomeration may be performed using a spray-fluidizer such as, for example, a fluidizer marketed by NIRO. Following agglomeration, the feed kaolin clay is green-screened, and undersized material is recirculated to the fluidizer to serve as seeds. According to some embodiments, 35 mesh screen may be used. Thereafter, the feed kaolin clay may be sintered in a kiln. For example, the feed may be heated in a kiln with the temperature being increased at a rate of, for example, 10° C. per minute until it reaches a temperature of, for example, 1,450° C. According to some embodiments, this temperature may be maintained for, for example, about an hour, and thereafter, the temperature may be reduced at a rate of, for example, about 5° C. per minute. Thereafter, the sintered and cooled material may be fed to a screening tower to classify the sintered material into different grades (e.g., oversized, undersized, and dust). Thereafter, the final sintered ceramic proppant may be obtained.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1-20. (canceled)

21. A method of forming ceramic proppants, the method comprising:
crushing a mineral ore via a crusher apparatus to form crushed mineral ore;
depositing the crushed mineral ore into a media mill;
adding water and dispersant into the media mill to form a slurry of the crushed mineral ore;
operating the media mill to grind the crushed mineral ore to form a slurry of ground mineral ore;
separating media of the media mill from the slurry of the ground mineral ore;
forming the ground mineral ore into green pellets; and
sintering the green pellets to form ceramic proppants,
wherein the mineral ore comprises at least one of bauxite and kaolin.

22. The method of claim 21, wherein the mineral ore comprises at least one of crude bauxite and crude kaolin, and crushing the mineral ore comprises crushing the at least one of crude bauxite and crude kaolin.

23. The method of claim 21, wherein the method does not comprise blunging the mineral ore, does not comprise blunging the crushed mineral ore, and does not comprise blunging the ground mineral ore.

24. The method of claim 21, wherein the method comprises feeding the crushed mineral ore from the crusher apparatus directly to the media mill.

25. The method of claim 21, wherein the media mill comprises at least one stirred media mill, and operating the media mill comprises operating the at least one stirred media mill.

26. The method of claim 25, wherein the media mill includes media comprising at least one of steel media and ceramic media.

27. The method of claim 25, wherein the at least one stirred media mill comprises at least one of a grinder having bars protruding from a rotating shaft into grinding media and a grinder having a cage rotor stirring the grinding media.

28. The method of claim 25, wherein operating the media mill to grind the crushed mineral ore comprises:
depositing the crushed mineral ore into a first media mill;
adding the water and the dispersant into the first media mill to form the slurry of the crushed mineral ore;
operating the first media mill to grind the crushed mineral ore to form the slurry of the ground mineral ore;
depositing the slurry of the ground mineral ore into a second media mill; and
operating the second media mill to grind the slurry of the ground mineral ore.

29. The method of claim 21, wherein the crusher apparatus comprises at least one of a jaw crusher and a horizontal shaft impactor.

30. The method of claim 21, wherein the dispersant comprises at least one of sodium lignosulfonate, sodium polyacrylate, and sodium polyphosphate.

31. The method of claim 21, wherein the slurry of the crushed mineral ore has a solids content ranging from about 30 wt % to about 75 wt %.

32. The method of claim 21, further comprising raising the pH of the slurry of the crushed mineral ore to 7 or more.

33. The method of claim 32, wherein raising the pH includes adding ammonium hydroxide to the slurry of the crushed mineral ore.

34. The method of claim 21, further comprising separating any grit particles from the slurry of the ground mineral ore.

35. The method of claim 34, wherein separating the grit particles comprises separating the grit particles via at least one of a hydrocyclone and a screen.

36. The method of claim 21, further comprising feeding the slurry of the ground mineral ore into a spray-fluidizer and operating the spray-fluidizer to form green pellets.

37. The method of claim 21, further comprising sizing the sintered pellets to form ceramic proppants.

38. The method of claim 21, wherein the slurry of the ground mineral ore has a Brookfield viscosity ranging from about 1 cps to about 1000 cps using a #2 spindle at 20 rpm at 65% equivalent solids.

39. The method of claim 21, wherein the slurry of the ground mineral ore has a Brookfield viscosity ranging from about 2 cps to about 200 cps using a #2 spindle at 20 rpm at 65% equivalent solids.
